(19) United States
(12) Patent Application Publication
(10) Pub. No.: US 2007/0259981 A1
(43) Pub. Date: Nov. 8, 2007

(54) Method for the Production of Rigid Polyurethane Foams

(75) Inventors: Berend Eling, Lemforde (DE); Anja Biedermann, Diepholz (DE); Andreas Emge, Lemforde (DE); Peter Von Malotki, Lemforde (DE); Seifert Holger, Bohmte (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengelellschaft, Ludwigshafen (DE)

(21) Appl. No.: 11/577,459

(22) PCT Filed: Oct. 12, 2005
(86) PCT No.: PCT/EP05/10955

§ 371 Date: Apr. 18, 2007

(30) Foreign Application Priority Data
Oct. 19, 2004 (DE) 10 2004 051 102.0

(51) Int. Cl. C08G 18/48; C08J 9/14

(52) U.S. Cl. 521/99; 521/170

(57) ABSTRACT

The invention relates to a process for producing rigid polyurethane foams by reacting a) polyisocyanates with b) compounds having at least hydrogen atoms which are reactive toward isocyanate groups, in the presence of c) blowing agents, wherein the compounds having at least hydrogen atoms which are reactive toward isocyanate groups comprise bi1) at least one polyether alcohol which has been initiated by means of sucrose and/or sorbitol and has a functionality of greater than 4 and a hydroxyl number in the range from 400 to 550 mg KOH/h, bi2) at least one polyether alcohol which has been initiated by means of TDA and has a hydroxyl number in the range from 120 to 240 mg KOH/g and an aromatics content in the range from 6.5 to 15% by weight, or a polyether alcohol which has been initiated by means of TMP and has a hydroxyl number in the range from 120 to 240 mg KOH/g, and, if appropriate, bi3) at least one polyether alcohol which has been inititated by means of a bifunctional or trifunctional alcohol and has a hydroxyl number in the range from 300 to 600 mg KOH/g.

The invention relates to a process for producing rigid polyurethane foams by reacting polyisocyanates with compounds having at least two hydrogen atoms which are reactive toward isocyanate groups.

Rigid polyuerthane foams have been known for a long time and are used predominantly for thermal insulation, e.g. in refrigeration appliances, in hot water storages, in district heating pipes or in building and construction, for example in sandwich elements. A summary overview of the preparation and use of rigid polyurethane foams may be found, for example, in the Kunststoff-handbuch, Volume 7, Polyurethane, 1st edition 1966, editted by Dr. R. Vieweg and Dr. A. Höchtlen, 2nd edition 1983, edited by Dr. Günter Oertel, and 3rd edition 1993, edited by Dr. Günter Oertel, Carl hanser Verlag, Munich, Vienna.

They are usually produced by reacting polyisocyanates with compounds having at least two hydrogen atoms which are reactive toward isocyanate groups in the rpesence of catalysts, blowing agents and auxilliaries and/or additives.

As compounds having at least two hydrogen atoms which are reactive toward isocyanate groups, use is usually made of polyether alcohols having a functionality of from 3 to 8 and a hydroxyl number of from 200 to 700 mg KOH/g. These are usually prepared by reacting H-functional starter substances with alkelene oxides. As starter substances, preference is given to using polyfunctional alcohols and amines. Examples of polyfunctional alcohols are glycerol, trimethylolpropane (TMP), sugars such as sorbitol, mannitol or sucrose. Examples of amines are aliphatic amines such as ethylenediamine, proplylenediamine, and aromatic amines such as toluenediamine (TDA), diphenylmethanediamine (MDA), if appropriate in admixture with its higher homologues.

Different polyurethane systems are required for the use of the rigid polyurethane foams. Since the number of available polyisocyanates is limited, the different properties of the systems are brought about by making changes in the compounds having at least two hydrogen atoms which are reactive toward isocyanate groups. In practice, this means that a large number of polyether alcohols is made available and these are processed by blending to give the desired polyurethane systems.

The customary large number of polyether alcohols causes problems with logistics, since separate containers are necessary for each type of polyether and frequent product changes have to be carried out in the production plants for the polyether alcohols.

There have therefore been many attempts in the past to simplify the preparation of systems for rigid polyurethane foams.

Thus, EP 768 325 describes a process for preparing polyol mixtures, in which the desired mixtures for the respective applications can be prepared from a number of base polyols by in-line mixing. The base polyols described in this document are compounds which are customary in industry and by means of which only a limited number of systems can be prepared.

It was therefore an object of the present invention to develop a process for producing rigid polyurethane foams, in which a large number of rigid foams can be made available for different fields of use from a limited number of polyols. The basic parameters determining the characteristics of a polyol are the hydroxyl number, the functionality and the viscosity. A person skilled in the art will pay particular attention to these parameters when selecting polyols for a particular application, because they are the most important guides for the development of the systems. In addition, the mechanical properties and, in particular, the processing properties of the foams should be improved further in the development of systems.

In the production of polyurethanes, total compatibility of polyol and isocyanate is not given. An improvement in the compatibility leads to reliable processing because an improved intrinsic compatibility of one component can compensate for poorer mixing. The solubility of pentane in polyols based on sucrose and sorbitol is relatively low. In some circumstances, especially when the pentane concentration in the polyol mixture is high and the pentane solubility is low, this can lead to formation of voids in the foam during the foaming process.

It has surprisingly been found that a polyol mixture comprising at least one poyether alcohol which has been initiated by means of sucrose and/or sorbitol and has a functionality of greatrer than 4 and a hydroxyl number in the range from 400 to 500 mg KOH/g, at least one polyether alcohol which has been initiated by means of TDA and/or TMP and has a hydroxyl number in the range from 120 to 240 mg KOH/g and optionally a diol and/or a polyether alcohol which has been initiated by means of glycerol and has a hydroxyl number in the range from 300 to 600 mg KOH/g makes it possible to prepare systems for the production of rigid polyurethane foams which satisfy most industrial requirements.

The invention accordingly provides a process for producing rigid polyurethane foams by reacting
a) polyisocyanates with
b) compounds having at least hydrogen atoms which are reactive toward isocyanate groups,
   wherein the compounds having at least hydrogen atoms which are reactive toward isocyanate groups comprise a mixture bi) comprising
bi1) at least one polyether alcohol which has been initiated by means of sucrose and/or sorbitol and has a functionality of greater than 4 and a hydroxyl number in the range from 400 to 550 mg KOH/g,
bi2) at least one polyether alcohol which has been initiated by means of TDA and has a hydroxyl number in the range from 120 to 240 mg KOH/g and an aromatics content in the range from 6.5 to 15% by weight, and/or a polyether alcohol which has been initiated by means of TMP and has a hydroxyl number in the range from 120 to 240 mg KOH/g, and, if appropriate,
bi3) at least one polyether alcohol which has been initiated by means of a bifunctional or trifunctional alcohol and has a hydroxyl number in the range from 300 to 600 mg KOH/g.

The reaction is carried out in the presenxce of blowing agents, catalysts and, if appropriate, auxiliaries and/or additives such as flame retardants, foam stabilizers or fillers.

The mixture bi) is preferably used in an amount of at least 50% by weight of the total weight of the compounds b) having at least hydrogen atoms which are reactive toward isocyanate groups. In particular, the components mentioned are used without addition of further compounds having at least hydrogen atoms which are reactive toward isocyanate groups.

The use of the polyols bi1), bi2) and bi3) alone is problematical and does not lead to usable foams. In the case of the sole use of the polyols bi1), their high viscosity would lead to problems in processing. In addition, the mechanical properties and the thermal stability of rigid foams produced using only the polyols bi3) would be unsatisfactory. The sole use of polyols bi2) would not lead to rigid foams but to a rubber-like mass which shrinks on cooling.

The components bi1, bi2) and bi3) are preferably used in such a ratio that the mixture bi) has a hydroxyl number of at least 300 mg KOH/g and a content of aromatics of less than 5% by weight. In particular, the mixture should have a viscosity of less than 10000 mPa·s at 25°. A foam produced using the mixture according to the invention of the polyols bi1), bi2) and bi3) at an isocyanate index of 100 preferably has a glass transition temperature of at least 100° C., determined from the G′ versus temperature curve determined by means of DMA measurement, as described in “Properties of Polymers”, D. W. Van Krevelen, Elsevier, 3rd edition, chapter 13.

The reaction of the polyisocyanates with the compounds having at least two hydrogen atoms which are reactive toward isocyanate groups is preferably carried out at an isocyanate index of from 90 to 200, particularly preferably from 100 to 150 and in particular from 110 to 130.

The mixture bi) preferably comprises 50-95% by weight of polyol bi1), 5-50% by weight of polyol bi2) and 0-50% by weight of oplyol bi3), in each case based on the weight of the mixture bi).

The polyols bi1), bi2) and bi3) are prepared by the customary and known methods by addition of alkylene oxides, usually propylene oxide, ethylene oxide or mixtures of the two alkylene oxides, onto H-functional starter substances. The addition reaction is usually carried out in the presence of catalysts, preferably basic catalysts, in particular potassium hydroxide.

To prepare the polyols bi1), the starter substances sucrose and sorbitol, if appropriate in admixture with short-chain alcohols and/or water, are reacted with the alkylene oxides.

The polyols bi2) are prepared by addition of alkylene oxides onto toluenediamine (TDA) or TMP. When TDA is used, it is in principle possible to employ all isomers of TDA in any mixtures. Preference is given to using mixtures comprising the ortho isomers of TDA, also referred to as vicinal TDA. The polyols prepared using vicinal TDA have a better solvent capability for hydrocarbon-containing blowing agents. Mixtures comprising vicinal TDA are obtained in the purification of TDA in the preparation of toluenediamine (TDI). The mixtures preferably comprise at least 80% by weight of vicinal TDA, particularly preferably at least 90% by weight of vicinal TDA and in particular at least 95% by weight of vicinal TDA. In a preferred embodiment, ethylene oxide is firstly added, preferably in an amount of from 5 to 20% by weight of the total amount of alkylene oxide, onto the TDA wothout use of a catalyst. In a second step, propylene oxyde is added on using potassium hydroxide as catalyst. As a result of the use of the component bi2), the viscosity of the component b) is decreased and the hydroxyl number is reduced. A reduction in the hydroxyl number leads to reduced crosslinking, which leads to a decrease in the glass transition temperature of the material. If the temperature of the foaming apparatus and thus the temperature of the foam is relatively low, a decrease in the glass transition temperature in the production of composite elements generally leads to improved adhesion of the foam to the covering layers. On the other hand, if the amount of the component bi2) in the formulation is too high, the foam becomes too soft and has a poor dimensional stability at elevated temperature.

The polyols bi3) are prepared by addition of alkylene oxides, in particular propylene oxide, onto bifunctional and trifunctional starter substances. Trifunctional starter substances used are, in particular, glycerol and trimethylopropane. Examples of bifunctional starter substances are ethylene glycol, diethylene glycol, propylene glycol and dipropylene glycol. The addition reaction of the propylene oxide is likewise carried out in the presence of a catalyst, in particular using potassium hydroxide as catalyst. Owing to the factor that the component bi3) has a very low viscosity, the use of the component bi3) greatly reduces the viscosity of the polyurethane system, so that an improved flowability is obtained. In the case of the component bi3), it is important to adhere to the specified hydroxyl number. If the hydroxyl n umber is too high, a deterioration in the adhesion and increased brittleness of the foam can occur. If the hydroxyl number is too low, aoftening of the foam and reduction in the dimensional stability can occur.

As regards the other compounds used in the process of the invention, the following may be said.

As polyisocyanates, use is made of the customary aliphatic, cycloaliphatic and in particular aromatic diisocyanates and/or polyisocyanates. Preference is given to using tolylene diisocyanate (TDI), dyphenylmethane diisocyanate (MDI) and in particular mixtures of diphenylmethane diisocyanate and polyphenylenepolymethylene polyisocyanates (crude MDI). The isocyanates can also be modified, for example by incorporation of uretdione, carbamate, isocyanurate, carbodiimide, allophanate and in particular urethane groups.

To produce rigid polyurethane foams, particular reference is given to using crude MDI. For various applications, it is advantageous to incorporate isocyanate groups into the polyisocyanate.

As mentioned above, the polyols bi1), bi2) and bi3) according to the invention are preferably reacted with the polyisocyanates in the absence of any further compounds having at least two hydrogen atoms which are reactive toward isocyanate groups. However, it can be advantageous to use further compounds having at least two hydrogen atoms which are reactive toward isocyanate groups, preferably in an amount of not more than 50% by weight.

As further compounds having at least two hydrogen atoms which are reactive toward isocyanate groups, use is made, in particular, of compounds having from 2 to 8 OH groups. Preference is given to using polyetherols and/or polyesterols. The hydroxyl number of the polyetherols and/or polyesterols used in the production of rigid polyurethane foams is preferably from 100 to 850 mg KOH/g, particularly preferably from 200 to 600 mg KOH/g, and the molecular weights are preferably greater than 400.

The polyurethanes can be produced with or without chain extenders and/or crosslinkers. Chain extenders and/or crosslinkers used are, in particular, bifunctional, trifunctional or tetrafunctional amines and alcohols, in particular ones having molecular weights of less than 400, preferably from 60 to 300.

Polypropylene glycols having molecular weights of from 400 to 2000 are added to improve the pentane solubility of the system.

As blowing agent, it is possible to use water which reacts with isocyanate groups to eliminate carbon dioxide. Physical blowing agents can also be used in combination with or preferably in place of water. Physical blowing agents are compounds which are inert toward the starting components and are ususally liquid at room temperature and vaporize under the conditions of the urethane reaction. the boiling point of these compounds is preferably below 50° C. Physical blowing agents also include compounds which are gaseious at room temperature and are introduced into or dissolved in the starting components under pressure, for example carbon dioxide, low boiling alkanes and fluoroalkanes.

The physical blowing agents are ususally selected from the group consisting of alkanes and cycloalkanes having at least 4 carbon atoms, dialkyl ethers, esters, ketones, acetals, fluoroalkanes having from 1 to 8 carbon atoms and tetraalylsilanes having from 1 to 3 carbon atoms in the alkyl chain, in particular tetramethylsilane.

Examples which may be mentioned are propane, n-butane, isobutane and cyclobutane, n-peptane, isopeptane and cyclopeptane, cyclohexane, dimethyl ether, methyl ethyl ether, methyl butyl ether, methyl formate, acetone and fluoroalkanes which can be degraded in the toposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane. The physical blowing agents mentioned can be used alone or in any combinations with one another. Preference is given to using isomers of pentane, in particular cyclopentane.

The polyurethane or polyisocyanurate foams usually further comprise flame retardants. Preference is given to using halogen-free flame retardants. Prticular preference is given to using phosphorous-containing flame retardants, in particular trischloroisopropyl phosphate, diethyl ethanephosphonate, triethyl phosphate and/or diphenylcresyl phosphate.

Catalysts used are, in particular, compounds which strongly accelerate the reaction of the isocyanate groups with the groups which are reactive toward isocyanate groups.

Such catalysts are strongly basic amines such as tertiary aliphatic amines, imidazoles, amidines and alkanolamines and/or organometallic compounds, in particular those base on tin.

If isocyanurate groups are to be incorporated into the rigid foam, specific catalysts are required. Isocyanurate catalysts used are usually metal carboxylates, in particular potassium acetate and solutions thereof.

The catalysts can, depending on requirements, be used alone or in any mixtures with one another.

Auxiliaries and/or additives used are the materials known per se for this purpose, for example surface-active substances, foam stabilizers, cell regulators, fillers, pigments, dyes, hydrolysis inhibitors, antistatics, fungistatic and bacteriostatic agents.

To produce the rigid foams based on isocyanates, the polyisocyanates and the compounds having at least two hydrogen atoms which are reactive toward isocyanate groups are rected in such amounts that the isocyanate index in the case of the polyurethane foams is in the range from 100 220, preferably from 115 to 180. The rigid polyurethane foams can be produced batchwise or continuously with the aid of known mixing apparatuses.

In the production of polyisocyanurate foams, it is also possible to employ an index of >180, preferably 300-400.

The mixing of the starting components can be carried out by means of known mixing apparatuses.

The rigid PUR foams of the invention are ususally produced by the two-component process. In the process, the compounds having at least two hydrogen atoms which are reactive toward isocyanate groups, the blowing agents, the catalysts and the further auxiliaries and/or additives are mixed to form a oplyol component and this is reacted with the polyisocyanates or mixtures of the polyisocyantes and, if appropriate, blowing agents, also referred to as isocyanate component.

The starting components are ususally mixed at a temperature of from 15 to 35° C., preferably from 20 to 30° C. The reaction mixture can be mixed using high-pressure or low-pressure matering machines.

The density of the rigid foams used for this purpose is preferably from 10 to 400 kg/m³, preferably 20-200 kg/m³, in particular from 30 to 100 kg/m³.

Further information regarding the starting materials, blowing agents, catalysts and auxiliaries and/or additives used for carrying out the process of the invention may be found, for example, in the Kunstoffhandbuch, Valume 7, “Polyurethane” Carl-Hanser-Verlag Munich, 1st edition, 1966, 2nd edition, 1983 and 3rd edition, 1993.

It has been found that the use of the polyol mixture according to the invention makes it possible to produce rigid polyurethane foams having a board property profile. For this purpose, the ratio of the three polyols can be varied within the abovementioned limits depending on the required property profile of the foam.

The polyol mixture used according to the invention has a very good compatibility with the polyisocyanates, an improved solvent capability for the blowing agents, in particular for cyclopentane, and leads to foams having an isotropic cell structure. The foams have a uniform cell structure without flaws and surface defects. As a result of the improved isotropy of the cells, the foams have a better stability at the same hrdness.

The rigid foams produced by the process of the invention can be used for many applications. Thus, they can be used in batchwise foam formation, for example for refrigeration appliances, hot water storages or pipe insulation, or for continuous foam formation, for example to produce composite elements using the double belt technology.

The invention is illustrated by the following examples.

Raw Materials Used

Polyols

Polyol A: prepared by addition of propylene oxide onto sorbitol, hydroxyl number=340 mg KOH/g, functionality=4.7

Polyol B: prepared by addition of propylene oxide onto a mixture of sucrose, pentaerythritol and diethylene glycol, hydroxyl number=405 KOH/g, functionality=3.9

Polyol C: prepared by addition of propylene oxide ontoa mixture of sucrose and diethylene glycol, hydroxyl number=440 mg KOH/g, functionality=4.3

Polyol D: prepared by addition of propylene oxide onto a mixture of sucrose and glycerol, hydroxyl number=400 mg KOH/g, functionality 4.5

Polyol E: polypropylene glycol, hydroxyl number=500 mg KOH/g, functionality=2

Polyol F: prepared by addition of ethylene oxide and subsequently propylene oxide onto vicinal TDA in a weight ratio of TDA/ethylene oxide/propylene oxide of 9.2/8.6/82.2, Hydroxyl number=160 mg KOH/g, functionality=3.9

Polyol G: prepared by addition of propylene oxide onto sorbitol, hydroxyl number=490 mg KOH/g, functionality=5.0

Polyol H: prepared by addition of propylene oxide onto a mixture of sucrose and glycerol, hydroxyl number=490 mg KOH/g, functionality=4.3

Polyol I: prepared by addition of propylene oxide onto TMP, hydroxyl number=160 mg KOH/g, functionality=3.0

Polyol J: prepared by addition of propylene oxide onto glycerol, hydroxyl number=400 mg KOH/g, functionality=3.0

Polyol K: prepared by addition of propylene oxide onto glycerol, hydroxyl number=160 mg KOH/g, functionality=3.0

Polyol L: prepared by addition of propylene oxide onto glycerol, hydroxyl number=230 mg KOH/g, functionality=3.0

Polyol M: prepared by addition of propylene oxide onto ethylenediamine, hydroxyl number=470 mg KOH/g, functionality=4.0

Polyol N: polypropylene glycol, hydroxyl number=105 mg KOH/g, functionality=2

Polyol O: prepared by addition of propylene oxide onto ethylenediamine, hydroxyl number=750 mg KOH/g, functionality=4.0

Polyisocyanates

Polyisocyanate I: Polymeric MDI having an NCO content of 31.5% by weight (Lupranat® M 20 S, BASF AG)

Polyisocyanate II: Prepolymer derived from 4,4′-MDI, NCO content=23% by weight (Lupranat® MP 102, BASF AG)

Addititves

Foam stabilizer 1: Tegostab® B 8467 from Goldschmidt

Foam stabilizer 2: Dabco® DC 193 from Air Products

Foam stabilizer 3: Tegostab® B 8443 from Goldschmidt

Foam stabilizer 4: Dabco® DC 5103 from Air Products

Foam stabilizer 5: Tegostab® B 8404 from Goldschnidt

Flame retardant: trischloroisopropyl phosphate (TCCP)

Flame retardant: triethyl phosphate (TEP)

Catalyst: dimethylcyclohehylamine (DMHCA)

### EXAMPLES 1 to 17

Polyol mixtures as described in Tables 1 and 2 were prepared. The isocyanate solubility and the pentane solubility were determined on the polyols or polyol mixtures and the glass transition temperature of foams produced from these mixtures was determined. the composition and the properties of the mixtures and the results obtained are recorded in Tables 1 and 2.

The experiments are designed so that a foam is produced from a known polyol (polyols A-D) (comparative examples 1, 4, 8 and 11). Mixtures of polyols according to the invention are then prepared using the polyols E-J, so that the mixtures have virtually the same hydroxyl number and functionality as the known polyol (Examples 2, 3, 5, 6, 7, 9, 10, 12 and 13). The hydroxyl number and functionality of the mixture should differ from that of the known polyol by not more than 10%. The examples 1-3, 4-7, 8-10 and 11-13 thus correspond. It has been found that the pentane solubility, isocyanate compatibility, glass transistion temperature and viscosity of the foams produced from the known polyols and the mixtures according to the invention are in the same range. Experiments 14-17 described rigid foams from mixtures of polyols K and L which are not according to the invention. Comparative example 14 is a comparison with the Examples 4, 5, 6 and 7, comparative example 15 is a comparison with the Examples 1,2 and 3 and the comparative examples 16 and 17 are a comparison with the Examples 11, 12 and 13. It was found that the polyol mixtures used in these comparative examples display poorer pentane solubilities, isocyanate compatibilities and glass transition temperatures.

TABLE 1

| Example | 1 (C) | 2 | 3 | 4(C) | 5 | 6 | 7 |
|---|---|---|---|---|---|---|---|
| Polyol A | | | | | | | |
| Polyol B | | | | 100 | | | |
| Polyol C | | | | | | | |
| Polyol D | 100 | | | | | | |
| Polyol E | | | | | 7 | 5 | |
| Polyol F | | 20 | | | 28 | | |
| Polyol G | | | | | | | |
| Polyol H | | 80 | 81 | | 65 | 73 | 65 |
| Polyol I | | | 19 | | | 22 | 15 |
| Polyol J | | | | | | | 20 |
| Polyol K | | | | | | | |
| Polyol L | | | | | | | |
| OH number (mg KOH/g) | 400 | 424 | 427 | 403 | 398 | 418 | 423 |
| Functionality | 4.5 | 4.3 | 4.2 | 3.9 | 3.9 | 3.9 | 3.9 |
| Pentane solubility (%) | 17 | 17 | 16 | 18 | 23 | 19 | 19 |
| Maximum concentration | 28 | 28 | 28 | 32 | 35 | 32 | 35 |
| (%) of isocyanate I in | | | | | | | |
| the isocyanate | | | | | | | |
| mixture | | | | | | | |
| T_{g} (° C.) | 131 | 129 | 130 | 116 | 116 | 122 | 119 |
| Viscosity (mPa•s) | 5500 | 5100 | 4500 | 2100 | 2900 | 2400 | 2300 |

| Experiment | 8 (C) | 9 | 10 | 11 (C) | 12 | 13 |
|---|---|---|---|---|---|---|
| Polyol A | | | | 100 | | |
| Polyol B | | | | | | |
| Polyol C | 100 | | | | | |
| Polyol D | | | | | | |
| Polyol E | | | | | | |
| Polyol F | | 10 | | | 40 | |
| Polyol G | | | | | 60 | 60 |
| Polyol H | | 90 | 91 | | | |
| Polyol I | | | 9 | | | 40 |
| Polyol J | | | | | | |
| Polyol K | | | | | | |
| Polyol L | | | | | | |
| OH number (mg KOH/g) | 440 | 464 | 460 | 340 | 358 | 358 |
| Functionality | 4.3 | 4.3 | 4.2 | 4.7 | 4.7 | 4.5 |
| Pentane solubility (%) | 12 | 14 | 14 | 31 | 36 | 38 |
| Maximum concentration (%) of | 20 | 23 | 23 | 25 | 30 | 30 |
| isocyanate I in the isocyanate | | | | | | |
| mixture | | | | | | |
| T_{g} (° C.) | 144 | 138 | 141 | 103 | 111 | 112 |
| Viscosity (mPa•s) | 7000 | 6600 | 6300 | 3500 | 3400 | 2800 |

TABLE 2

| Example | 14 (C) | 15 (C) | 16 (C) | 17 (C) |
|---|---|---|---|---|
| Polyol A | | | | |
| Polyol B | | | | |
| Polyol C | | | | |
| Polyol D | | | | |
| Polyol E | 5 | | | |
| Polyol F | | | | |
| Polyol G | | | 54 | 62 |
| Polyol H | 69 | 78 | | |
| Polyol K | | 22 | | 38 |
| Polyol L | 26 | | 46 | |
| OH number (mg KOH/g) | 423 | 417 | 370 | 365 |
| Functionality | 3.8 | 4.1 | 4.2 | 4.5 |
| Pentane solubility (%) | 16 | 16 | 32 | 32 |
| Maximum concentration (%) of | 13 | 13 | 13 | 13 |
| isocyanate I in the isocyanate | | | | |
| mixture | | | | |
| T_{g} ° C.) | 117 | 121 | 92 | 94 |
| Viscosity (mPa•S) | 2540 | 3150 | 2620 | 2540 |

Determination of the Pentane Solubility:

50 g of polyol were placed in a 100 ml bottle. A predetermined amount of cyclopentane was added, the bottle was closed, shaken vigorously for 5 minutes and the bottle was stored for one hour. The mixture was then assessed visually. If the mixture was clear and stable, the experiment was repeated with a larger amount of cyclopentane. If the mixture was tubrid, the experiment was repeated using a smaller amount of cyclopentane. In this way, the maximum concentration of cyclopentane in the mixture is determined. The concentration is referred to as “maximum pentane solubility” in a polyol or a polyol mixture. The accuracy of this method is 1%.

Determination of the Isocyanate Compatibility:

Polymeric MDI, e.g. isocyanate I, and polyols or polyol mixtures are not miscible. Isocyanate II, a prepolymer, is completely miscible with polyols or polyol mixtures. Mixtures of the isocyanates I and II can, depending on the ratio of the isocyanates, be miscible. To determine the miscibility, 1 g of polyol is placed on a clock glass having a diameter of 4 cm. 1 g of a mixture of isocyanate I and isocyanate II is added to the polyol and the mixture is mixed with a spatula for one minute so that no gas bubbles are formed. One minute after stirring is stopped, the mixture is assessed visually. If the mixture is turbid, the experiment is repeated using a mixture having a higher content of isocyanate II. If the mixture is clear, the experiment is repeated using a mixture having a lower content of isocyanate II. In this way, the maximum concentration of isocyanate I in the mixture at which the mixture is still clear is determined. The accuracy of this method is 2%.

Determination of the Glass Transition temperature T_{g}

A mixture pf 100 g of polyol mixture, 2.4 g of foam stabilizer, 15 g of cyclopentane and the amount of DMHCA necessary for a gel time of from 45 to 90 seconds is prepared. This mixture is foamed with isocyanate I at an index of 100. The mixture is calculated so that 50 g of foam are formaed. The required amounts are placed in a cardboard cup having a capacity of 735 ml and stirred at 1500 mion⁻¹ for 10 seconds. After foaming was complete, the foam was stored for 3 days. A 2 mm thick slice was then cut from the upper part of the foam. A rectangular specimen having edge lengths of 58 mm×12 mm was cut from this slice. G′ was determined as a function of the temperature on the speciment using a Rheometric Scientific Ares DMA instrument. The measurement was carried out at a frequency of 1 Hz and a measurement was recorded every 5° C. The glass transition temperature was determined as described in “Properties of Polymers”, D. W. Van Krevelen, Elsevier, 3rd edition, chapter 13.

### EXAMPLES 18 to 30

A mixture consisting of 100 parts by weight of polyol or polyol mixture, 2.4 parts by weight of foam stabilizer 1 and 0.85 part by weight of water and also cyclopentane and DMHCA is foamed with isocyanate 1 at an index of 100. The precise amounts used are given in Table 2. Foaming was carried out in a cubic mold having a volume of 11.4 I. After 20 minutes, the foam was taken out and stored for 3 days.

The density of the foam was determined in accordance with ISO 845, and the compressive strength parallel to and transverse to the foaming direction was measured in accordance with ISO 604.

The amounts of raw materials used and the measured values are recorded in Table 3.

It was surprisingly found that the mechanical properties of the foams from the known polyols A and D agree well with those of the mixtures according to the invention.

TABLE 3

| Example | 18 (C) | 19 | 20 | 21 (C) | 22 | 23 | 24 |
|---|---|---|---|---|---|---|---|
| Polyol A | | | | | | | |
| Polyol B | | | | 100 | | | |
| Polyol C | | | | | | | |
| Polyol D | 100 | | | | | | |
| Polyol E | | | | | 7 | 5 | |
| Polyol F | | 20 | | | 28 | | |
| Polyol G | | | | | | | |
| Polyol H | | 80 | 81 | | 65 | 73 | 67 |
| Polyol I | | | 19 | | | 22 | 18 |
| Polyol J | | | | | | | 15 |
| Polyol K | | | | | | | |
| Polyol L | | | | | | | |
| Water | 0.85 | 0.85 | 0.85 | 0.85 | 0.85 | 0.85 | 0.85 |
| Cyclopentane | 13.8 | 14.8 | 13.8 | 14.5 | 14.8 | 14.5 | 14.6 |
| Dimethylcyclo- | 5.9 | 5.3 | 5.7 | 5.8 | 5.3 | 5.8 | 5.6 |
| hexlyamine | | | | | | | |
| Surfactant 1 | 2.4 | 2.4 | 2.4 | 2.4 | 2.4 | 2.4 | 2.4 |
| Reactivity: | | | | | | | |
| Gel time (s) | 55 | 57 | 55 | 55 | 56 | 54 | 54 |
| Rise time (s) | 85 | 87 | 85 | 85 | 85 | 85 | 83 |
| Mechanical | | | | | | | |
| properties: | | | | | | | |
| Density (kg/m³) | 36.3 | 35.6 | 36.2 | 37.9 | 37.4 | 37.7 | 34.8 |
| Compressive | 0.30 | 0.27 | 0.30 | 0.26 | 0.26 | 0.27 | 0.21 |
| strength | | | | | | | |
| transverse to | | | | | | | |
| the foaming | | | | | | | |
| direction | | | | | | | |
| (N/mm²) | | | | | | | |
| Compressive | 0.08 | 0.10 | 0.10 | 0.09 | 0.09 | 0.09 | 0.06 |
| strength | | | | | | | |
| parallel to the | | | | | | | |
| foaming direction | | | | | | | |
| (N/mm²) | | | | | | | |

| Example | 25 (C) | 26 | 27 | 28 (C) | 29 | 30 |
|---|---|---|---|---|---|---|
| Polyol A | | | | 100 | | |
| Polyol B | | | | | | |
| Polyol C | 100 | | | | | |
| Polyol D | | | | | | |
| Polyol E | | | | | | |
| Polyol F | | 10 | | | 40 | |
| Polyol G | | | | | 60 | 60 |
| Polyol H | | 90 | 91 | | | |
| Polyol I | | | 9 | | | 40 |
| Polyol J | | | | | | |
| Polyol K | | | | | | |
| Polyol L | | | | | | |
| Water | 0.85 | 0.85 | 0.85 | 0.85 | 0.85 | 0.85 |
| Cyclopentane | 13.8 | 14.8 | 13.8 | 15.0 | 14.8 | 15.0 |
| Dimethylcyclo- | 5.7 | 5.4 | 5.7 | 6.5 | 5.3 | 6.5 |
| hexlyamine | | | | | | |
| Surfactant 1 | 2.4 | 2.4 | 2.4 | 2.4 | 2.4 | 2.4 |
| Reactivity: | | | | | | |
| Gel time (s) | 55 | 57 | 55 | 55 | 57 | 56 |
| Rise time (s) | 85 | 83 | 85 | 90 | 93 | 90 |
| Mechanical properties: | | | | | | |
| | 36.9 | 36.7 | 36.5 | 37.1 | 35.6 | 36.6 |
| Compressive strength | 0.32 | 0.3 | 0.33 | 0.23 | 0.24 | 0.20 |
| transverse to the foaming | | | | | | |
| direction (N/mm²) | | | | | | |
| Compressive strength | 0.08 | 0.13 | 0.09 | 0.07 | 0.09 | 0.06 |
| parallel to the foaming | | | | | | |
| direction (N/mm²) | | | | | | |

### EXAMPLES 31 and 33

The systems shown in Table 3 were processed with flexible covering layers in a double belt plant. The composite elements has a good foam quality without defects. The foams were produced using isocyanate I at an index of 115.

TABLE 3

| Example | 31 | 32 | 33 |
|---|---|---|---|
| Polyol E | 3.0 | 2.3 | 2.65 |
| Polyol F | 13.3 | 14.55 | 16.2 |
| Polyol G | 20.0 | 10.0 | |
| Polyol H | 32.5 | 42.0 | 47.2 |
| Polyol K | 12.0 | 10.0 | |
| Polyol L | | | 30.0 |
| Polyol M | | 2.0 | |
| Glyerol | 1.5 | 1.5 | 2.0 |
| Foam stabilizer 2 | 0.5 | | 0.5 |
| Foam stabilizer 3 | 0.5 | 1.0 | |
| Foam stabilizer 4 | | | 0.5 |
| Foam stabilizer 5 | | | 0.5 |
| Water | 1.5 | 1.5 | 3.0 |
| Dimethylcyclohexylamine | 3.0 | 3.0 | 3.45 |
| TCPP | 15.0 | 12.0 | |
| TEP | | 3.0 | |
| n-Pentane | 6.0 | 6.0 | |
| Layer thickness (mm) | 40 | 170 | 50 |
| Overall density (kg/m³) | 43 | 38 | 45 |
| Density of core (kg/m³) | 38 | 37 | 44 |
| Compressive strength | 0.12 | 0.11 | 0.18 |
| (N/mm²) | | | |

1-12. (canceled)

13. A process for producing rigid polyurethane foams by reacting
a) polyisocyanates with
b) compounds having at least hydrogen atoms which are reactive toward isocyanate groups,
in the presence of
c) blowing agents,
wherein the compounds having at least hydrogen atoms which are reactive toward isocyanate groups comprise a mixture bi) consisting of
bi1) 50-95% by weight of at least one polyether alcohol which has been intitiated by means of sucrose and/or sorbitol and has a functionality of greater than 4 and a hydroxyl number in the range from 400 to 550 mg KOG/g,
bi2) 5-50% by weight of at least one polyether alcohol which has been initiated by means of TDA having a content of at least 80% by weight of vicinal toluenediamine and has a hydroxyl number in the range from 120 to 240 mg KOH/g and an aromatics content in the range from 6.5 to 15% by weight,
bi3) 0-50% by weight of at least one polyether alcohol which has been initiated by means of a bifunctional or trifunctional alcohol and has a hydroxyl number in the range from 300 to 600 mg KOG/g.

14. The process according to claim 13, wherein the mixture bi) makes up at least 50% by weiight of the total weight of the compounds b) having at least hydrogen atoms which are reactive toward isocyanate groups.

15. The process according to claim 13, wherein the mixture bi) has a hydroxyl number of at least 300 mg KOH/g and a content of aromatocs of less than 5% by weight.

16. The process according to claim 13, wherein the mixture bi) has a viscosity of less than 10000 mPa·s at 25° C.

17. The process according to claim 13, wherein the polyols i2) are prepared by addition of alkylene oxides onto toluene diamine having a content of at least 90% by weight of vicinal toluenediamine.

18. The process according to claim 13, wherein the polyols bi2) are prepared by addition of alkylene oxides onto toluenediamine having a content of at least 95% by weight of vixinal toluenediamine.

19. The process according to claim 13, wherein cride MDI is used as polyisocyanates.

20. The process according to claim 13, wherein hydrocarbons are used as blowing agents.

21. A rigid polyurethane foam which can be produced according to claim 13.

22. The rigid polyurethane foam according to claim 21 which at an isocyanate index of 100 has a glass transition temperature of at least 100° C.
